(19) United States
(12) Patent Application Publication
(10) Pub. No.: US 2006/0181257 A1
(43) Pub. Date: Aug. 17, 2006

(54) Current mirror

(75) Inventors: Hugo Veenstra, Eindhoven (NL); Godefridus Adrianus Maria Hurkx, Eindhoven (NL); Johannes Hubertus Antonius Brekelmans, Eindhoven (NL); Dave Willem Van Goor, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics., N.V., Eindhoven (NL)

(21) Appl. No.: 10/548,252

(22) PCT Filed: Mar. 1, 2004
(86) PCT No.: PCT/IB04/50169

§ 371 Date: Sep. 6, 2005

(30) Foreign Application Priority Data
Mar. 10, 2003 (EP) 03100594-5

(51) Int. Cl. G05F 3/16

(52) U.S. Cl. 323/315

(57) ABSTRACT

The present invention relates to Current mirror for generating a constant mirror ratio, comprising an output transistor (Tₒᵤt) having a base, an emitter and a collector, wherein a current flowing through the collector of said output transistor (Tₒᵤₜ) constitutes an output current (Iₒᵤₜ) of said current mirror and the collector of said output transistor (Tₒᵤₜ) is connectable to an output circuit, a buffer transistor having a base, an emitter and a collector, wherein the emitter of the buffer transistor is connected to the base of the output transistor, a buffer current source for providing a fixed buffer current, wherein said buffer current source is connected to the collector of the buffer transistor, and a buffer base voltage control means having an input connected to the base of the output transistor and an output connected to the base of the buffer transistor, wherein the base voltage control means is adapted to controlling a voltage at the base of the buffer transistor in response to a current at the input of the buffer base voltage control means.

The present invention relates to a current mirror for generating a constant input current/output current ratio. The current mirror comprises an output transistor having a base, an emitter and a collector. A current flowing through the collector of said output transistor constitutes an output current of said current mirror. The collector of said output transistor is connectable to an output circuit.

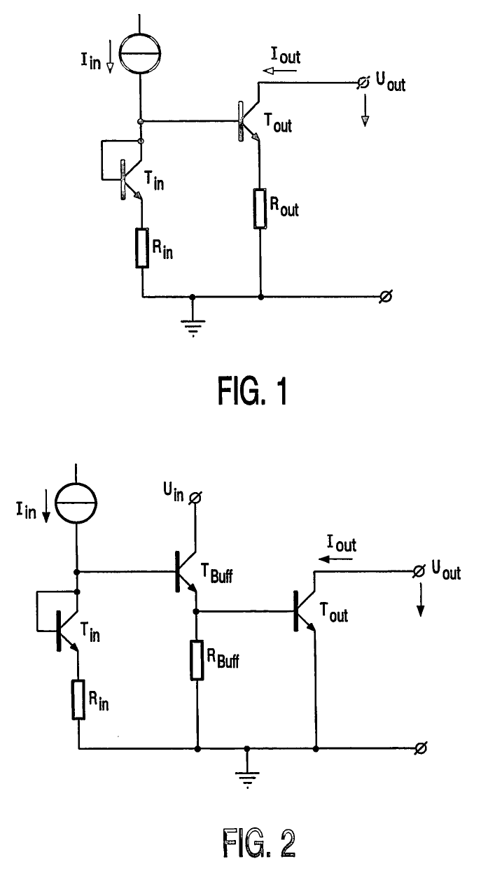

FIG. 1 shows a simple current mirror according to the state of the art. An input current source supplying an input current Iᵢₙ to an input conductor of the circuit is shown in FIG. 1. The input conductor is connected to the base of an output transistor Tₒᵤₜ and the base and collector of an input transistor Tᵢₙ. Thus, the input transistor may be regarded as a diode which has an anode connected to the input current source. The forward voltage drop across the base and emitter of the input transistor Tᵢₙ may be regarded as being constant for typical currents. The emitter of the input transistor Tᵢₙ is connected to an input resistor Rᵢₙ that in turn is connected to ground potential. The collector current of the output transistor Tₒᵤₜ constitutes the output current Iₒᵤₜ of the current mirror. The emitter of the output transistor Tₒᵤₜ is connected to an output resistor Rₒᵤₜ that in turn is connected to ground potential. An arbitrary output circuit (not shown) is connected to the collector of the output transistor Tₒᵤₜ. Thus, an output voltage Uₒᵤₜ between the collector of the output transistor Tₒᵤₜ and ground potential is supplied. This output voltage Uₒᵤₜ depends on the supply voltage of the arbitrary output circuit. The output voltage depends in particular on the input impedance of the output circuit. The resistors Rᵢₙ and Rₒᵤₜ are optional, i.e. the conventional current mirror may be implemented without using these resistors. In case resistors are not used the mirror ratio Iₒᵤₜ/Iᵢₙ depends alone on the size of the transistors Tᵢₙ and Tₒᵤₜ. Under normal operating conditions the mirror ratio K of the conventional current mirror may be determined by the following equation:
K=Iₒᵤₜ/Iᵢₙ=n/(1+(n+1)/B).

B is the current gain of both transistors Tₒᵤₜ and Tᵢₙ. The current gain of both transistors is chosen to be equal. n stands for the ratio between the emitter area of the output transistor Tₒᵤₜ and the input transistor Tᵢₙ. If input and output resistors Rᵢₙ and Rₒᵤₜ are used, the quotient Rᵢₙ/Rₒᵤₜ is chosen to be equal to n. In this case the above equation also describes the conventional current mirror containing input and output resistors. The output resistor Rₒᵤₜ increases the output impedance of the current mirror and reduces the current noise. In order for the current mirror to work properly the collector-emitter voltage of the output transistor U_{ce}(Tₒᵤₜ) has to be larger than the saturation voltage of the output transistor U_{ce,sat}(Tₒᵤₜ) and lower than the collector-emitter break down voltage U_{brce}(Tₒᵤₜ) of the output transistor. If the collector-emitter voltage of the output transistor U_{ce}(Tₒᵤₜ) exceeds the break down voltage due to fluctuations in the output voltage Uₒᵤₜ, the current mirror does not operate accurately anymore, i.e. the mirror ratio is changed. By increasing the voltage drop across the output resistor Rₒᵤₜ the maximum output voltage Uout for proper operation of the current mirror may be increased, since Uout equals U_{ce}(Tₒᵤₜ)+Urout, wherein Uᵣₒᵤₜ depicts the voltage drop cross the output resistor Rₒᵤₜ. As a draw back the minimum output voltage Uout for proper operation of the current mirror is also increased. It is good to increase the output voltage range of the current mirror in order to provide for a stable and accurate operation of the current mirror, even if output voltage fluctuations occur. This can be achieved by providing an output transistor Tₒᵤₜ that has a large collector-emitter break down voltage U_{brce}(Tₒᵤₜ). However, modern silicon and silicon-germanium transistors used in integrated circuits are designed to operate at constantly increasing frequencies, which in turn leads to reducing the break down voltages of these transistors. It is therefore desirable to provide a current mirror that operates correctly even if the collector-emitter voltage of the output transistor U_{ce}(Tₒᵤₜ) exceeds the break down voltage of the output transistor. When the output transistor Tₒᵤₜ is operated in the break down region, an additional current flows from the collector of transistor Tₒᵤₜ into its base. These base currents are generated because of an avalanche effect occurring at the base-collector junction of the transistor Tₒᵤₜ. The size of the avalanche current is equivalent to:
Iₐᵥ=(M−1)I_{S}*exp(U_{be}/U_{T}).

U_{be} stands for the base/emitter voltage of the output transistor Tₒᵤₜ. U_{T} is the temperature voltage of the output transistor. I_{S} is the reverse saturation current of the output transistor. M is a factor that depends on the collector-base voltage of the output transistor U_{cb}(Tₒᵤₜ). If the collector-base voltage of the output transistor is an order of magnitude lower than the collector-base break down voltage, the factor M is approximately equal to 1. The avalanche current may be neglected. Factor M may be calculated from: M=1/[1−(U_{cb}(Tₒᵤₜ)/BVCBO)^{L}]. The typical value for L is 3 and BVCBO is the collector-base break down voltage at open emitter. As can be seen from this formula, factor M approaches infinity for U_{cb}(Tₒᵤₜ) close to the collector-base break down voltage BVCBO. If the avalanche current is taken into account, the mirror ratio of the current mirror according to FIG. 1 may be described by the following formula:
K=Iₒᵤₜ/Iᵢₙ=n¤M/[1+n/B−n(M−1)]

Since M depends on the collector base voltage of the output transistor U_{cb}(Tₒᵤₜ) the mirror ratio depends on the output voltage. The avalanche current flowing into the base of the output transistor Tₒᵤₜ reduces the base current of the output transistor Tₒᵤₜ. Since the current source in FIG. 1 produces a constant current, which is equivalent to the base current of the output transistor and the current flowing through the input resistor Rᵢₙ, a reduction in the base current of the output transistor is compensated by an increase of the current flowing through the input resistor Rᵢₙ. An increased current flow through the input resistor Rᵢₙ in turn leads to an increased voltage drop cross the input resistor, since U=R*I. A constant voltage drop across the base emitter junction of the input transistor Tᵢₙ, may be assumed under normal operating conditions. Therefore, the base voltage of the output transistor Tₒᵤₜ increases. Finally, the increased base voltage of the output transistor increases the collector current (=output current) of the output transistor Tₒᵤₜ. In order to prevent an increase of the output current, the base voltage of the output transistor must be maintained on a constant level.

An improved current mirror according to the state of the art is shown in FIG. 2. In FIGS. 1 and 2 the same reference signs depict the same components. In FIG. 2 a buffer transistor T_{buff} and a buffer resistor R_{buff} have been added to the circuit of FIG. 1. The base of the buffer transistor T_{buff} is connected to the input conductor of the input current source Iᵢₙ. The collector of the buffer transistor T_{buff} is connected to an input voltage source providing a constant input voltage Uᵢₙ. The emitter of said buffer transistor connects with the base of the output transistor Tₒᵤₜ and the buffer resistor R_{buff}. The resistors Rᵢₙ, R_{buff} and Rₒᵤₜ are all connected to ground potential. The bias current of the buffer transistor T_{buff} is dimensioned in such a way, that the base current flowing into the buffer transistor is negligible compared to the current flowing through the input transistor Tᵢₙ. Therefore, the base voltage of the buffer transistor T_{buff} is approximately equal to Rᵢₙ*Iᵢₙ plus a constant voltage drop across the input transistor Tᵢₙ. The base voltage of the buffer transistor T_{buff} may be assumed to be constant. The input voltage source, the buffer transistor T_{buff} and the buffer resistor R_{buff} constitute as a first approximation a current source providing a fairly constant current flowing through the buffer resistor R_{buff}. As long as the current flowing through the buffer resistor R_{buff} is held constant, the base voltage of the output transistor is left unchanged. The primary purpose of inserting the buffer transistor and the buffer resistor into the current mirror is to maintain a constant base voltage at the output transistor Tₒᵤₜ, even if a negative avalanche current is inserted into the buffer of the output transistor. The effect of a negative current in the base of the output transistor Tₒᵤₜ on the circuit of FIG. 2 may be explained in detail in the following way. The negative base current adds to the current flowing through the buffer resistor R_{buff}. Consequently, the emitter voltage of the buffer transistor is raised. Since the base voltage of the buffer transistor T_{buff} is approximately constant, a rise in the emitter voltage of the transistor T_{buff} leads to a reduced base emitter voltage drop at the buffer transistor T_{buff}. As a consequence the emitter current of the buffer transistor T_{buff} is reduced.

The current mirror of FIG. 2 has several drawbacks. The current flowing constantly through the buffer resistor R_{buff} leads to increased power dissipation of the current mirror. The functioning of the circuit is limited by the size of the current flowing through the buffer transistor R_{buff}. If the negative base current flowing to the base of the output transistor Tₒᵤₜ is equal to or larger than the current flowing through the buffer resistor under normal operating conditions, reducing the emitter current emanating from the buffer transistor T_{Buff} cannot compensate an increase in the buffer current.

It is therefore object of the present invention to provide a current mirror for generating a constant mirror ratio that operates accurately for a large output voltage range.

The problem is solved by the current mirror for generating a constant mirror ratio according to the present invention. The current mirror comprises an output transistor (Tₒᵤₜ) having a base, an emitter and a collector. A current flowing through the collector of said output transistor (Tₒᵤₜ) constitutes an output current (Iₒᵤₜ) of said current mirror. The collector of said output transistor (Tₒᵤₜ) is connectable to an output circuit. The current mirror further comprises a buffer transistor having a base, an emitter and a collector. The emitter of the buffer transistor is connected to the base of the output transistor. The current mirror further comprises a buffer current source for providing a fixed buffer current. The buffer current source is connected to the collector of the buffer transistor. The current mirror comprises a buffer base voltage control means having an input connected to the base of the output transistor and an output connected to the base of the buffer transistor. The base voltage control means is adapted to controlling a voltage at the base of the buffer transistor in response to a current at the input of the buffer base voltage control means. If the output transistor is operated at output voltages exceeding the base emitter break down voltage of the output transistor, negative base currents are injected into the base of the output transistor due to an avalanche effect at the base emitter junction of the output transistor. The base current of the output transistor is reduced. If the buffer transistor is operated in the normal operating range, the collector and emitter current of the buffer transistor are approximately equal to each other. Since the collector of the buffer transistor is connected to a buffer current source, the emitter current of the buffer transistor is constant, even if the base current of the output transistor is reduced. Therefore the reduction in the base current of the output transistor must lead to an increase of the current at the input of the base voltage control means. The base voltage control means may reduce the voltage at the base of the buffer transistor in response to an increase in the input current Since the collector current of the buffer transistor is fixed by the buffer current source, the base emitter voltage drop at the buffer transistor must be assumed to be constant. Therefore a reduction in the voltage at the base of the buffer transistor leads to an equivalent drop in the voltage at the emitter of the buffer transistor. Since the emitter of the buffer transistor is connected to the base of the output transistor, the voltage at the emitter of the buffer transistor and at the base of the output transistor are equal to each other. Consequently, the voltage at the base of the output transistor is reduced. The base voltage of the output transistor is reduced whenever negative base currents occur due to an avalanche effect. Thereby an increase in the collector current of the output transistor due to output voltages exceeding the collector emitter break down voltage of the output transistor may be compensated.

The current mirror according to the present invention operates accurately for a larger output voltage range than the current mirrors according to the state of the art since the compensation of negative base currents of the output transistor is not limited by the size of the buffer current.

Preferably the current mirror according to the present invention comprises an input conductor. The input conductor is connected to the base of the buffer transistor and an input resistor. The input conductor is connectable to an input current source. The buffer base voltage control means comprises a buffer current mirror having an input and an output. The input of the buffer current mirror constitutes the input of the buffer base voltage control means and the output of the buffer current mirror constitutes the output of the buffer base voltage control means.

The base voltage of the buffer transistor is controlled according to this embodiment by mirroring the negative base current of the output transistor onto the base of the buffer transistor. The negative base current of the output transistor increases the current flowing into the input of the current mirror. This increase of input current is mirrored onto the output of the current mirror. The sum of the currents supplied to the input resistor, the output of the buffer current mirror and the base of the buffer transistor is fixed, if the input conductor is connected to an input current source. Since the collector current of the buffer transistor is fixed by the buffer current source, the base current of the buffer transistor must be assumed to be constant. An increase of the current supplied to the output of the buffer current mirror must lead to a decrease in the current supplied to the input resistor. The voltage drop across the input resistor is decreased. Consequently, the voltage at the base of the buffer transistor is decreased.

The buffer current mirror preferably comprises a buffer current mirror input transistor having a base, a collector and an emitter. The collector of the buffer current mirror input transistor constitutes the input of the current mirror. The buffer current mirror preferably further comprises a buffer current mirror output transistor having a base, a collector and an emitter. The collector of the buffer current mirror output transistor constitutes the output of the buffer current mirror. The base of the buffer current mirror output transistor and the base of the buffer current mirror input transistor are connected to each other. The voltage at the base of the buffer current mirror input transistor may be chosen in such a way, that the fixed buffer current predominantly flows through the collector of the buffer current mirror input transistor. Since the base emitter voltage of the buffer current mirror output transistor equals the base emitter voltage drop of the buffer current mirror input transistor, these two transistors form a current mirror with a collector current ratio k. The emitter area of the buffer current mirror input transistor is equal to k times the emitter area of the buffer current mirror output transistor. For correct operation of the overall current mirror ratio should be chosen to be the reciprocal value of the buffer current mirror ratio. This buffer current mirror provides a constant current mirror ratio without fixing the voltage at its input terminal. The current mirror of FIG. 1 fixes the voltage at its input terminal. This is not possible in the current mirror according to the invention, since the voltage at the input of the buffer current mirror has already been defined as the emitter voltage of the buffer transistor. Therefore, a current mirror is needed that accepts any input voltage.

A buffer mirror ratio of the buffer current mirror is preferably chosen to be the reciprocal value of the mirror ratio of the current mirror. This can be achieved by choosing the emitter area ratio of the buffer current mirror output transistor and the buffer current mirror input transistor to be equal to the reciprocal value of the mirror ratio of the current mirror. This buffer mirror ratio is needed to provide the exact amount of compensation current to the input current. The input current is mirrored n times towards the output current. Any correction factor to this input current will also be seen n times as large in the output current. The avalanche current (to be corrected) appears exactly once in the output current. Since this avalanche current is corrected in the input current, the input current must be corrected by the scaled amount, so 1/n times. This current mirror requires an input current equal to (1+1/m) times the buffer current, wherein the overall current mirror ratio is equal to m/(1+1/m).

The buffer current mirror comprises preferably a PMOS transistor having a gate, a source and a drain. The source of the PMOS transistor is connected to the collector of the buffer transistor and the drain of the PMOS transistor is connected to the base of the buffer current mirror input transistor. The drain of the PMOS transistor is adapted to providing a base voltage to the buffer current mirror input transistor. This base voltage must be high enough for the collector buffer current mirror input transistor to absorb the predominant part of the buffer current emanating from the emitter of the buffer transistor. At the same time the current flowing to the source of the PMOS transistor must be negligible in comparison with the buffer current. Instead of a PMOS transistor a PnP transistor may be implemented accordingly.

The above and other features and advantages of the invention will be apparent from the following description of the exemplary embodiments of the invention with reference to the accompanying drawings, in which:

FIG. 1 shows a simple current mirror according to the state of the art,

FIG. 2 shows a current mirror with a buffer according to the state of the art,

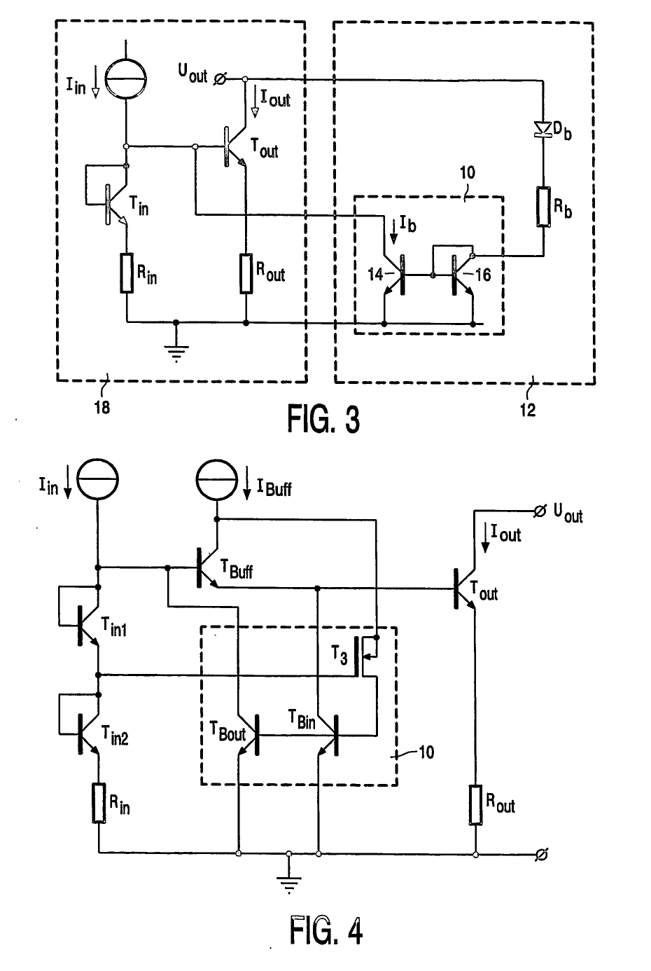

FIG. 3 shows a first embodiment of the current mirror according to the present invention, and

FIG. 4 shows a second embodiment of the current mirror according to the present invention.

In all FIGS. 1 to 4 an output current Iₒᵤₜ is provided to an arbitrary output circuit (not shown). The collector of the output transistor Uₒᵤₜ is connected to the output circuit. The output circuit is connected between SUPPLY potential and Uₒᵤₜ. Thus Uₒᵤₜ constitutes both the output voltage of the current mirrors shown in FIG. 1 to 4 and the voltage supplied to the arbitrary output circuit. The size of the output voltage Uₒᵤₜ depends on the output circuit and particularly on the input impedance of the output circuit.

The first embodiment of the present invention shown in FIG. 3 comprises an input transistor Tᵢₙ, an output transistor Tₒᵤₜ an input resistor Rᵢₙ and an output resistor Rₒᵤₜ. Identical reference signs in FIG. 1 to 4 depict the same components. Please refer to the detailed description of the conventional current mirrors shown in FIGS. 1 and 2. The collector current of the output transistor constitutes the output current of the current mirror. An input current source is provided in order to provide a constant input current Iᵢₙ. The input transistor Tᵢₙ is connected to the input current source with its collector and base. Therefore the input transistor Tᵢₙ may be regarded as a diode. The input resistor Rᵢₙ is connected to the emitter of the input transistor Tᵢₙ and is connected to ground potential. A buffer transistor T_{Buff} is connected to the input current source via its base. The emitter of the buffer transistor T_{Buff} is connected to the base of the output transistor Tₒᵤₜ. The emitter of output transistor Tₒᵤₜ is connected to ground via the output resistor Rₒᵤₜ.

A first difference between the current mirror of FIG. 3 and the current mirror of FIG. 2 is the use of a buffer current source in order to generate a buffer current I_{Buff}. The buffer current I_{Buff} is provided to the collector of the buffer transistor T_{Buff}. If the buffer transistor T_{Buff} is operated under normal operating conditions, i.e. the collector emitter voltage of the buffer transistor T_{Buff} is larger than the collector emitter saturation voltage and lower than the collector emitter break down voltage, the collector current of the buffer transistor T_{Buff} depends almost exclusively on the base emitter voltage of the buffer transistor T_{Buff}. A given collector current of the buffer transistor T_{Buff} implicates a given base emitter voltage drop at the buffer transistor T_{Buff}, which is almost independent of the collector emitter voltage of the buffer transistor T_{Buff}. Therefore, the base emitter voltage drop of the buffer transistor T_{Buff} is defined by the buffer current I_{Buff} provided to the collector of the buffer transistor T_{Buff}. The base current of the buffer transistor T_{Buff} is almost exclusively a function of the base emitter voltage of the buffer transistor T_{Buff} under normal operating conditions. For a given base emitter voltage of the buffer transistor T_{Buff} a predetermined base current may be found. Hence, the buffer current source defines the base current of the buffer transistor T_{Buff}. The voltage at the base of the buffer transistor T_{Buff} is equal to the voltage drop across the input resistor Rᵢₙ plus a voltage drop across the input transistor Tᵢₙ. The voltage drop across input transistor Tᵢₙ may be assumed to be constant, since the input transistor Tᵢₙ is operated as a diode. Hence, the base voltage of the buffer transistor depends on the current flowing through the input resistor Rᵢₙ. Since the base emitter voltage of the buffer transistor T_{Buff} is fixed for a given buffer current I_{Buff}, the emitter voltage of the buffer transistor T_{Buff} (equal to base voltage of output transistor Tₒᵤₜ) can be controlled by changing the current flowing through the input resistor Rᵢₙ. This effect is used to control the base voltage of the output transistor Tₒᵤₜ. A reduction in the current flowing through the input resistor Rᵢₙ is effected by a buffer current mirror 10, if a negative base current is injected into the base of the output transistor Tₒᵤₜ. The buffer current mirror 10 has an input, which is connected to the base of the output transistor Tₒᵤₜ and the emitter of the buffer transistor T_{Buff}. The current emanating from the emitter of the buffer transistor T_{Buff} corresponds approximately to the buffer current I_{Buff} and is fixed. Therefore, the buffer current I_{Buff} is equal to the base current of the output transistor Tₒᵤₜ plus the input current of the current mirror 10. If a negative base current is injected into the base of the output transistor Tₒᵤₜ the base current of the output transistor Tₒᵤₜ is reduced. The input current of the buffer current mirror 10 must increase by the same amount. Otherwise the sum of the input current of the buffer current mirror 10 and the base current of the output transistor Tₒᵤₜ would cease to correspond to the buffer current I_{Buff}. The negative base currents from the output transistor Tₒᵤₜ are injected completely into the input of the buffer current mirror 10. The output of the buffer current mirror 10 is connected to the base of the buffer transistor T_{Buff} and the input current source. An increase in the input current of the buffer current mirror 10 is mirrored onto the output current, i.e. the output current increases proportionally. The fixed input current of the buffer current mirror 10 is equal to the sum of the current flowing through the input resistor Rᵢₙ the current in the base of the buffer transistor T_{Buff} and the current flowing to the output of the buffer current mirror 10. The base current of the buffer transistor T_{Buff} is fixed. Consequently an increase in the output current of the buffer current mirror 10 must lead to a reduction in the input resistor current. Reducing the current flowing through the input resistor Rᵢₙ in turn reduces the voltage at the base of the output transistor Tₒᵤₜ. Thereby the effect of negative base currents on the output transistor Tₒᵤₜ may be compensated.

The second embodiment of the present invention shown in FIG. 4 contains a special current mirror 10, which is particularly adapted to the requirements of a buffer current mirror. This buffer current mirror allows a correct current copying without fixing the voltage at its input terminal. Furthermore, two input transistors Tᵢₙ₁ and Tᵢₙ₂ are used in the second embodiment. The input transistors Tᵢₙ₁ and Tᵢₙ₂ are operated as diodes and connected in line to the input current source and the base of the buffer transistor T_{Buff}. Otherwise the current mirror shown in FIG. 4 corresponds to the current mirror shown in FIG. 3. The input transistors Tᵢₙ₁, and Tᵢₙ₂ do not change the operating principle of the current mirror. The voltage at the base of the buffer transistor T_{Buff} may still be controlled by changing the current flowing through the input resistor Rᵢₙ. The base emitter voltage drop across the input transistors Tᵢₙ₁, and Tᵢₙ₂ may be assumed to be constant, since they are operated as diodes. The gate of a PMOS transistor T₃ is connected to the emitter of Tᵢₙ₁ and the collector of Tᵢₙ₂. Since the gate current of a PMOS transistor is approximately zero under normal operating conditions, this connection has no effect on the current flowing through the input resistor. The purpose of connecting the gate of the PMOS T₃ transistor with the input transistors Tᵢₙ₁ and Tᵢₙ₂ is to define the gate voltage of T₃ in an appropriate way. The source of transistor T3 is connected to the collector of the buffer transistor T_{Buff}. This does not change the functioning of the current mirror, since the PMOS transistor is designed and operated in such a way, that the current flowing to the source of transistor T3 is negligible in comparison to the buffer current I_{Buff}. The main purpose of transistor T3 is to provide a proper base voltage of transistor T_{Bin}. The buffer current mirror 10 shown in FIG. 4 consists of the PMOS transistor T3, a buffer current mirror input transistor T_{Bin} and a buffer current mirror output transistor T_{Bout}. The base of the input transistor T_{Bin} and the base of the output transistor T_{Bout} are connected to each other. The PMOS transistor T3 defines the base voltage of the input and output transistors T_{Bin} and T_{Bout} respectively. The input of the buffer current mirror 10 corresponds to the collector of the input transistor T_{Bin}. The base emitter voltage drop at the input transistor T_{Bin} is chosen in such a way, that the buffer current I_{Buff} is predominantly conducted through the input transistor T_{Bin}. The output of the buffer current mirror 10 corresponds to the collector of the output transistor T_{Bout}. The emitters of the buffer current mirror input and output transistors T_{Bin} and T_{Bout} are both connected to ground potential. An increase in the input current of the buffer current mirror leads to an increased base emitter voltage drop at the input transistor T_{Bin} of the buffer current mirror. Since the base of the input transistor T_{Bin} and the output transistor T_{Bout} are connected to each other, the increase of the base emitter voltage of the input transistor T_{Bin} leads to a corresponding increase in the base emitter voltage of the output transistor T_{Bout}. The collector current of the input transistor T_{Bin} corresponds approximately to Ic(T_{Bin})=exp(U_{be}(Tᵢₙ)/U_{T})*I_{S}(T_{Bin}). The collector current of the output transistor T_{Bout} corresponds approximately to Ic(Tₒᵤₜ)=exp(U_{be}(T_{Bout})/U_{T})*I_{S}(T_{Bout}). U_{T} is the temperature voltage of the output transistor and input transistor of the buffer current mirror. Since the base emitter voltage U_{be} of the output transistor T_{Bout} and the input transistor T_{Bin} are equal to each other, the buffer current mirror ratio corresponds to I_{c}(T_{Bout})/Ic(T_{Bin})=I_{S}(T_{Bout})/I_{S}(T_{Bin}). Is stands for the reverse saturation current of the output transistor T_{Bout} and the input transistor T_{Bin} respectively. The reverse saturation current of a transistor depends on the design of the transistors and in particular on the emitter area of the transistor. Therefore the buffer current mirror ratio may be defined by choosing the emitter areas of the input and output transistors T_{Bin} and T_{Bout} of the buffer current mirror in an appropriate way.

For correct operation, the circuits of FIGS. 3 and 4 require an input current Iᵢₙ which is equal to (1+1/m) times the buffer current I_{Buff} provided by the buffer current source, i.e. Iin=(1+1/m)¤I_{Buff}, wherein the overall current mirror ratio is chosen to be equal to m/(1+1/m). The buffer current mirror ratio Ic(T_{Bout})/Ic(T_{Bin}) must be chosen to correspond to the reciprocal value of the overall current mirror ration Iₒᵤₜ/Iᵢₙ.

It is clear to the person skilled in the art, that the present invention may be implemented in various ways not explicitly mentioned in this application. The previous embodiments are only exemplary and do not limit the scope of the invention. The invention is defined by the following claims.

1. Current mirror for generating a constant mirror ratio, comprising:
an output transistor (Tₒᵤₜ) having a base, an emitter and a collector, wherein a current flowing through the collector of said output transistor (Tₒᵤₜ) constitutes an output current (Iₒᵤₜ) of said current mirror and the collector of said output transistor (Tₒᵤₜ) is connectable to an output circuit,
a buffer transistor having a base, an emitter and a collector, wherein the emitter of the buffer transistor is connected to the base of the output transistor,
a buffer current source for providing a fixed buffer current, wherein said buffer current source is connected to the collector of the buffer transistor, and
a buffer base voltage control means having an input connected to the base of the output transistor and an output connected to the base of the buffer transistor, wherein the base voltage control means is adapted to controlling a voltage at the base of the buffer transistor in response to a current at the input of the buffer base voltage control means.

2. Current mirror according to claim 1, further comprising:
an input conductor, wherein the input conductor is connected to the base of the buffer transistor and an input resistor and the input conductor is connectable to an input current source and
the buffer base voltage control means comprises a buffer current mirror having an input and an output, wherein the input of the buffer current mirror constitutes the input of the buffer base voltage control means and the output of the buffer current mirror constitutes the output of the buffer base voltage control means.

3. Current mirror according to claim 2, wherein the buffer current mirror comprises a buffer current mirror input transistor having a base, a collector and an emitter, wherein the collector of the buffer current mirror input transistor constitutes the input of the current mirror, and a buffer current mirror output transistor having a base, a collector and an emitter, wherein the collector of the buffer current mirror output transistor constitutes the output of the buffer current mirror and the base of the buffer current mirror output transistor and the base of the buffer current mirror input transistor are connected to each other.

4. Current mirror according to claim 2, wherein a buffer mirror ratio of the buffer current mirror is chosen to be the reciprocal value of the mirror ratio of the current mirror.

5. Current mirror according to claim 3, wherein the buffer current mirror comprises an PMOS transistor having a gate, a source and a drain, wherein the source of the PMOS transistor is connected to the collector of the buffer transistor and the drain of the PMOS transistor is connected to the base of the buffer current mirror input transistor.

6. Current mirror according to claim 3, wherein the buffer current mirror comprises a pnp-type bipolar transistor having a base, a collector and an emitter, wherein the emitter of the pnp-type bipolar transistor is connected to the collector of the buffer transistor and the collector of the pnp-type bipolar transistor is connected to the base of the buffer current mirror input transistor.
